(19) United States
(12) Patent Application Publication
(10) Pub. No.: US 2010/0208693 A1
(43) Pub. Date: Aug. 19, 2010

(54) NEIGHBOUR CELL LIST CREATION/MAINTENANCE AND NEIGHBOUR CELL NODE INTERFACE ESTABLISHMENT

(76) Inventor: Angelo Centonza, Winchester (DE)

Correspondence Address: HARRINGTON & SMITH, 4 RESEARCH DRIVE, Suite 202, SHELTON, CT, 06484-6212, US

(21) Appl. No.: 12/672,322

(22) PCT Filed: Aug. 11, 2008
(86) PCT No.: PCT/EP08/60535

§ 371 Date: Mar. 1, 2010

(30) Foreign Application Priority Data
Aug. 9, 2007 (GB) 0715484.2

(51) Int. Cl. H04W 36/00

(52) U.S. Cl. 370/331

(57) ABSTRACT

Apparatus, including means for providing connectivity information for at least one neighbour cell in a neighbour cell list, said information being dependent on the result of a connectivity check carried out to measure the performance of a route between the apparatus and a respective base station associated with the at least one neighbour cell.

The present invention relates to a neighbour cell list. In particular, the present invention relates to providing connectivity information for at least one neighbour cell in a neighbour cell list.

In the third generation partnership project (3GPP) long term evolution (LTE) standardisation work there is ongoing study of the use in LTE networks of so called Home Node Bs (HNBs). A HNB is meant to provide indoor coverage to e.g. a household via LTE radio technology and network architecture support. The user is the owner of the home base station and the connection between the HNB and the operator's network is intended to be achieved via internet connections commonly available to private users, e.g. x digital subscriber line (xDSL).

One of the main issues when deploying HNBs is how to guarantee service continuity and efficient handover to neighbour cells, or to overlapping macro cells. A “neighbour cell” is a cell which is adjacent or proximate to the cell with which the home base station is associated. A “macro cell” comprises a large cell that is optimized to provide coverage rather than capacity, the coverage of which overlaps small cells, such as micro cells, pico cells and femto cells. A solution for such a problem implies the availability of a neighbour cell list as well as appropriate interfaces between the HNB and the neighbour base stations (such interface being called X2) that will allow performance of e.g. handover procedures, data forwarding, measurements exchange etc.

Use of a neighbour cell list at the HNB is intended to facilitate hand over procedures from HNB to macro cell and between HNBs, i.e. in the corporate scenario.

In 3GPP it is desirable to support seamless mobility between HNBs and overlapping macro or between neighbour HNBs.

If a cell is listed in the neighbour cell list it means that handover is possible from the cell owning the list to the cell listed. However, handover procedures strongly benefit from the presence of an X2 interface between the serving and target cell, such interface mainly being used for data forwarding during handovers.

Cells with poor connectivity are automatically included in the neighbour cell list of the HNB and X2 interfaces with such cells will eventually be established. However, due to the poor performance of the end to end connection between the X2 interface end-points, data forwarding, seamless handovers or fast measurements exchanges are not possible (i.e. will not be timely or reliably performed), nullifying the advantages of establishing the X2 interface or keeping the cell in the neighbour cell list. Eventually the UE will be guided to hand over to target cells with poor connectivity with the HNB serving cell, resulting in service interruption due to consequent break before make handovers.

Due to the way HNBs are going to be connected to the operator's network, i.e. via relatively cheap and low performance backhaul, establishment of X2 interfaces will not always be subject to the QoS an X2 would need. One example of degraded QoS is that where the end to end connectivity between the serving and target base stations allows for delays in excess of the maximum limit allowed for data forwarding. The latter nullifies the benefits of establishing an X2 interface and it prompts deletion of the respective cell from the neighbour cell list.

This invention is aimed at providing a method according to which such process of neighbour cell list creation/maintenance is defined, and it aims to reduce or eliminate one or more of the above problems.

A particular problem addressed by this invention is that of allowing neighbour cell list creation and maintenance depending on whether X2 interfaces can be enabled between the node owning the list and the nodes on the list.

At its most general, the present invention provides connectivity information for an entity on a list in dependence on a measurement of the characteristics of a route between the entity on the list and another entity.

According to a first aspect, the present invention may provide an apparatus, comprising means for providing connectivity information for at least one neighbour cell in a neighbour cell list, said information being dependent on the result of a connectivity check carried out to measure the performance of a route between the apparatus and a respective base station associated with the at least one neighbour cell.

The connectivity check may comprise a check to determine whether an interface is capable of establishment over the route. The interface may be for the performance of at least one of a handover procedure, data forwarding, and measurements exchange between the apparatus and the base station. The neighbour cell list may be at the apparatus.

The means for providing connectivity information may comprise means for creating the neighbour cell list. The means for providing connectivity information may comprise means for updating the neighbour cell list. The apparatus may further comprise means for receiving a list of one or more neighbour cell identities. The apparatus may comprise means for requesting the list of one or more neighbour cell identities. The means for providing connectivity information may be arranged to provide the connectivity information in dependence on the list of one or more neighbour cell identities received.

The apparatus may comprise means for reporting the neighbour cell list to a server, such as an operation and maintenance (OAM) server. The server could then perform a coherence check with other neighbour cell lists received from neighbour nodes and prompt for a rescan if it detects an inconsistency between the lists. The apparatus may further comprise means, such as a receiver or transceiver, for receiving from a server a prompt to rescan for one or more neighbour cell identities.

The apparatus may include means for requesting permission from an entity, such as a mobility management entity (MME), for the apparatus to establish the interface with the respective base station in the at least one neighbour cell. The permission request may be for permission to establish an interface with a base station of one cell, or with a base station of each of a plurality or all of the cells on the list. The connectivity check may be carried out once the entity grants permission for the apparatus to establish the interface or interfaces.

The apparatus preferably includes means for performing the connectivity check. The connectivity check may include calculating at least one of round trip delay, packet loss, and sustainable throughput on the route between the apparatus and the respective base station.

The apparatus may include means for removing a neighbour cell from the neighbour cell list in dependence on results of the connectivity check. The apparatus may comprise means for notifying a server, such as an OAM server, that a neighbour cell, or plural neighbour cells, has been removed from the neighbour cell list.

The apparatus may include means for establishing an interface with the respective base station in the at least one neighbour cell included in the list. Such establishment may be carried out in dependence on the result of the connectivity check.

The apparatus may comprise a base station, such as a home base station. The apparatus may comprise a component part of a base station, and may comprise an electronic chip e.g. within a base station. The apparatus may include means for broadcasting the neighbour cell list within a cell associated with the apparatus/base station.

The at least one neighbour cell may include at least one of a neighbour cell (such as a HNB or an eHNB) and an overlapping macro cell.

According to a second aspect, the present invention may provide a method, comprising providing connectivity information for at least one neighbour cell in a neighbour cell list, said information being dependent on the result of a connectivity check carried out to measure the performance of a route between the apparatus and a respective base station associated with the at least one neighbour cell.

According to a third aspect, the present invention may provide a computer program embodied on a computer readable medium, said computer program configured to control a processor to perform providing connectivity information for at least one neighbour cell in a neighbour cell list, said information being dependent on the result of a connectivity check carried out to measure the performance of a route between the apparatus and a respective base station associated with the at least one neighbour cell.

According to a fourth aspect, the present invention may provide an apparatus, comprising circuitry arranged to provide connectivity information for at least one neighbour cell in a neighbour cell list, said information being dependent on the result of a connectivity check carried out to measure the performance of a route between the apparatus and a respective base station associated with the at least one neighbour cell.

According to a fifth aspect, the present invention may provide an apparatus, comprising means for receiving a first neighbour cell list including at least one neighbour cell from a home base station; and means for detecting an inconsistency between the neighbour cell list received from the home base station and at least one neighbour cell list received from at least one respective base station, which respective base station neighbours the home base station.

The apparatus of the fifth aspect of the present invention may include means for prompting the home base station to rescan for an element (or elements) of the first neighbour cell list which generates the inconsistency or plural inconsistencies. Moreover, the apparatus of the fifth aspect may further comprise means for receiving a notification from the home base station that a neighbour cell (or plural cells) has been removed from the first neighbour cell list.

The apparatus of the fifth aspect of the present invention may comprise a server, such as an OAM server, or part of a server. For example, the apparatus of the fifth aspect may comprise an electronic chip e.g. within a server.

According to a sixth aspect, the present invention may provide a method, comprising receiving a first neighbour cell list including at least one neighbour cell from a home base station; and detecting an inconsistency between the neighbour cell list received from the home base station and at least one neighbour cell list received from at least one respective base station, which respective base station neighbours the home base station.

According to a seventh aspect, the present invention may provide a computer program embodied on a computer readable medium, said computer program configured to control a processor to perform receiving a first neighbour cell list including at least one neighbour cell from a home base station; and detecting an inconsistency between the neighbour cell list received from the home base station and at least one neighbour cell list received from at least one respective base station, which respective base station neighbours the home base station.

According to an eighth aspect, the present invention may provide an apparatus, comprising a receiver arranged to receive a first neighbour cell list including at least one neighbour cell from a home base station; and a detector arranged to detect an inconsistency between the neighbour cell list received from the home base station and at least one neighbour cell list received from at least one respective base station, which respective base station neighbours the home base station.

The present invention is not applicable only to whether X2 interfaces are capable of establishment, but is applicable to other interfaces, such as other interfaces between base stations, which preferably allow the performance of e.g. handover procedures, data forwarding, and measurements exchange.

Embodiments of this invention relate to a method to create and maintain neighbour cell lists at the HNB and also relate to a way of checking whether X2 interfaces with neighbour base stations can be established or not.

Embodiments of the invention are not concerned with defining how to create a neighbour cell list from the information received from neighbour or overlapping cells via broadcast radio channels, such as primary broadcast channel (P-BCH).

As the scenario of HNB deployment is relatively new, the problem of neighbour cell list creation/maintenance has always undergone procedures taking into account network, planning and fairly static deployment scenarios. Some solutions have been proposed for the HNB scenario, where the HNB can detect (by acting as a receiver) the P-BCH channel of neighbour cells and derive their cell ID information. However, this way of creating/maintaining the cell ID list does not take into account the backhaul connectivity factors between the HNB and the operator's network or between the HNB and its neighbour base stations.

Ideally it is desirable to ensure that the eNode Bs (eNBs), or HNBs reported in the neighbour cell list of a HNB are also connected to the HNB via a X2 interface. This improves handover to the cells listed in the neighbour cell list. However, due to the backhaul connectivity of HNBs and to the performance it may be subject to, it is foreseen that establishing X2 interfaces with all possible neighbour cells may not be feasible.

Embodiments of the present invention provide criteria as to how X2 interfaces can be setup depending on the entries in the neighbour cell list and/or how the neighbour cell list is maintained depending on X2 interface establishment.

An example of the present invention will now be described with reference to the accompanying drawing, in which:

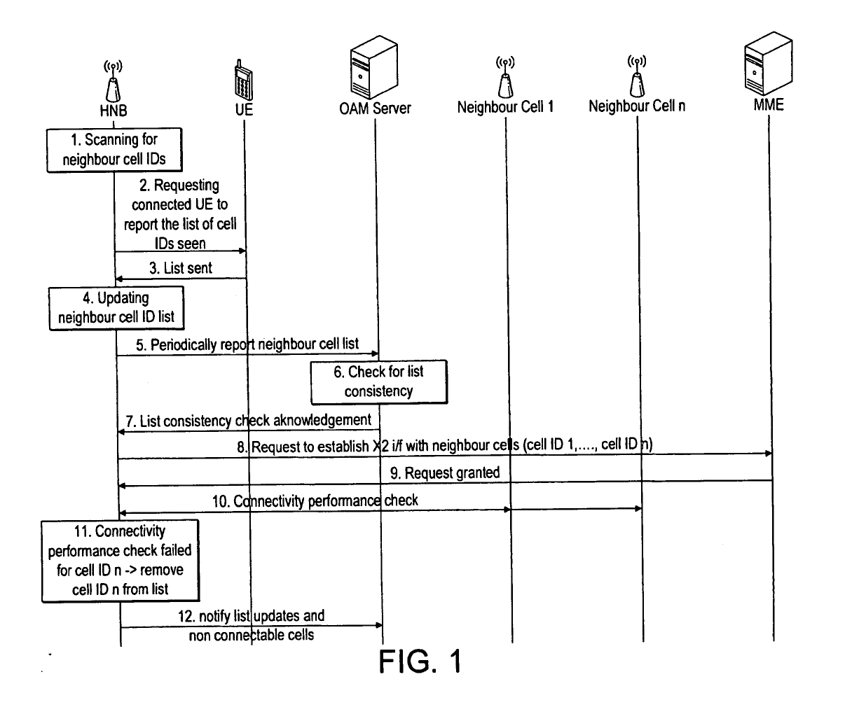

FIG. 1 shows a graphical representation (message sequence chart) of the procedures for neighbour cell list creation and maintenance according to one embodiment of the present invention; and

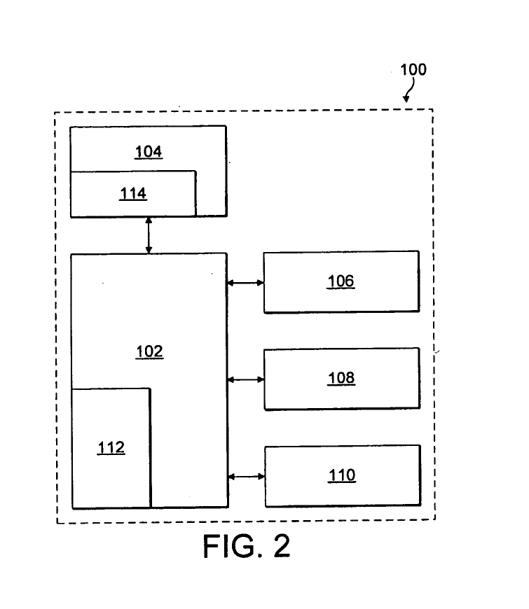

FIG. 2 shows a representation of an apparatus according to one embodiment of the present invention.

It is to be noted that the order of the steps illustrated in the example embodiment of FIG. 1 is not intended to limit the scope of the invention to a series of steps carried out in that particular order. In some embodiments some of the illustrated steps may be carried out in a different order, combined, or even omitted, and yet the other embodiments will be examples of the invention.

At cell setup, home base station (in this embodiment a home node B, or HNB), or rather a scanner of the home base station, scans for received Cell IDs and forms a first list of neighbour cells. The list may include one or more neighbour cells, or rather the list may include information identifying one or more neighbouring cells. The HNB periodically requests that user equipments (UEs) connected to the HNB provide a list of received cell IDs in order to update its neighbour cell list. Such updating may be carried out by circuitry in the home base station. In other embodiments, the request for cell identities may be sent to an entity other than a UE, and an entity other than a UE may provide the list of IDs to the HNB. In this embodiment, the HNB periodically reports the neighbour cell list formed to an operation and maintenance (OAM) server. Having received the list, the OAM server then performs a coherence check with other neighbour cell list received from neighbour nodes. If an inconsistency between the neighbour cell lists submitted to the OAM server by neighbour eNBs/HNBs is detected, the OAM server prompts a rescan for the elements of the neighbour cell lists generating the inconsistency.

Once a stable neighbour cell list has been achieved, as shown in FIG. 1 the HNB requests that the network, i.e. a mobility management entity (MME) grants permission for the HNB to establish an X2 interface with the eNBs/HNBs populating the neighbour cell list. Once permission to establish an X2 interface with such nodes is granted the HNB performs a connectivity check with each of the nodes with which an X2 needs to be established. Such a test may consist of calculating e.g. the round trip delay, packet loss, sustainable throughput on the end to end route between the HNB and the node with which an X2 needs to be established.

As one of the main purposes of the X2 is to allow data forwarding in handover procedures, an excessive end to end delay along the X2 would impair any type of data forwarding and may neutralise the benefits of such interface. If such a situation is registered the HNB does not attempt to establish an X2 interface with such a node and it eliminates the respective cell ID from its neighbour cell list. Such an event is notified to the OAM server with the appropriate event description, so that the OAM can efficiently detect true anomalies in an HNB's neighbour.

HNBs deployed without undergoing any network planning procedures will not have a preconfigured neighbour cell list. Further, HNBs need to re-create a neighbour cell list in case they are moved from their usual location. If mobility between HNBs and overlapping macro or home neighbour cells has to be provided it is essential in one embodiment of the invention that the HNB broadcasts a neighbour cell list within its cell. If seamless mobility needs to be guaranteed (this being the working assumption at least for the HNB <-> overlapping macro cell scenario) the base stations associated with the cells in the HNB neighbour cell list also preferably need to establish a X2 interface with the HNB owning the list.

FIG. 2 shows an embodiment of the apparatus of the present invention. FIG. 2 shows a home base station (100) comprising circuitry (102), memory (104), a transmitter (106), a receiver (108) and further circuitry (110) for establishing an X2 interface with another base station. In other embodiments, the further circuitry (110) may be incorporated into the circuitry (102). In other embodiments the transmitter (106) and receiver (108) may be combined as a transceiver, rather than being separate. Indeed, in other embodiments of the invention any of the individual blocks shown in FIG. 2 may be combined with others of the individual blocks.

The circuitry (102) carries out the above-mentioned scanning for cell IDs which have been received via the receiver (108) from user equipment. The circuitry (102) forms a neighbour cell list and holds it in the memory (104). In other embodiments, the neighbour cell list (114) is provided to the home base station (100). In any event the circuitry (102) provides connectivity information for at least one neighbour cell on the neighbour cell list (114).

Connectivity checking circuitry (112) in the circuitry (102) carries out the above-mentioned connectivity check. In other embodiments, the connectivity checking circuitry (112) is an element in the base station (100) separate from the circuitry (102). In further embodiments still, the home base station (100) receives the result of a connectivity check carried out at entity separate from the home base station (100) via the receiver (108).

The transmitter (106) is used for sending requests for the list of cell identities, reporting the neighbour cell list to the OAM server, requesting permission from the MME for permission to establish the X2 interface with the base stations in the neighbouring cells listed in the neighbour cell list, for notifying the OAM when a neighbour cell is removed from the neighbour cell list, and for broadcasting the neighbour cell list. In other embodiments, some or all of these processes are carried out by different elements of the home base station (100), rather than all being carried out by the transmitter (106).

The receiver (108) is used for receiving the list of neighbour cell identities from user equipment and for receiving the prompt from the OAM. In other embodiments these processes are carried out by separate or different elements of the home base station (100).

An advantage of the present invention is that X2 interfaces are established by taking into account the performance of the connectivity route between the two end nodes of the X2 interface. Such performance is not guaranteed in the HNB scenario because the HNB is connected to the IP world by means of cheap and highly available broadband connections such as xDSL. Efficient neighbour cell list creation and maintenance for HNBs is thus preferred for supporting effective mobility.

The disadvantages of not using the present invention include the fact that cells with poor connectivity are automatically included in the neighbour cell list of the HNB and X2 interfaces with such cells will eventually be established. However, due to the poor performance of the end to end connection between the X2 interface end-points, data forwarding, seamless handovers or fast measurements exchanges are not possible (i.e. will not be timely or reliably performed), nullifying the advantages of establishing the X2 interface or keeping the cell in the neighbour cell list. Eventually the UE will be guided to hand over to target cells with poor connectivity with the HNB serving cell, resulting in service interruption due to consequent break before make handovers.

This invention may also be used in other technologies such as GPRS GUN or more generally in cases where a home base station is deployed with no particular network planning or connectivity performance checks and where interfaces need to be established between such base station and other elements in the network.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto.

While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs) and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims.

1. Apparatus, comprising:
means for providing connectivity information for at least one neighbour cell in a neighbour cell list,
said information being dependent on the result of a connectivity check carried out to measure the performance of a route between the apparatus and a respective base station associated with the at least one neighbour cell.

2. Apparatus as claimed in claim 1, wherein the connectivity check comprises a check to determine whether an interface is capable of establishment over the route.

3. Apparatus as claimed in claim 2, wherein the interface is for the performance of at least one of a handover procedure, data forwarding, and measurements exchange between the apparatus and the base station.

4. Apparatus as claimed in claim 1, wherein the neighbour cell list is at the apparatus.

5. Apparatus as claimed in claim 1, wherein the means for providing connectivity information comprises means for creating the neighbour cell list.

6. Apparatus as claimed in claim 1, wherein the means for providing connectivity information comprises means for updating the neighbour cell list.

7. Apparatus as claimed in claim 1, further comprising means for receiving a list of one or more neighbour cell identities.

8. Apparatus as claimed in claim 7, further comprising means for requesting the list of one or more neighbour cell identities.

9. Apparatus as claimed in claim 7, wherein the means for providing connectivity information is arranged to provide the connectivity information in dependence on the list of one or more neighbour cell identities received.

10. Apparatus as claimed in claim 1, further comprising means for reporting the neighbour cell list to a server.

11. Apparatus as claimed in claim 10, further comprising means for receiving from the server a prompt to rescan for one or more neighbour cell identities.

12. Apparatus as claimed in claim 1, further comprising means for requesting from an entity permission for the apparatus to establish the interface with the respective base station in the at least one neighbour cell.

13. Apparatus as claimed in claim 1, further comprising means for performing the connectivity check.

14. Apparatus as claimed in claim 1, wherein the connectivity check includes calculating at least one of round trip delay, packet loss, and sustainable throughput on the route between the apparatus and the respective base station.

15. Apparatus as claimed in claim 1, wherein the means for providing connectivity information comprises means for removing a neighbour cell from the neighbour cell list in dependence on results of the connectivity check.

16. Apparatus as claimed in claim 1, further comprising means for notifying a server that a neighbour cell has been removed from the neighbour cell list.

17. Apparatus as claimed in claim 2, further comprising means for establishing the interface with the respective base station in the at least one neighbour cell included in the list.

18. Apparatus as claimed in claim 1, wherein the at least one neighbour cell includes at least one of a neighbour cell and an overlapping macro cell.

19. Method, comprising:
providing connectivity information for at least one neighbour cell in a neighbour cell list,
said information being dependent on the result of a connectivity check carried out to measure the performance of a route between the apparatus and a respective base station associated with the at least one neighbour cell.

20. Method as claimed in claim 19, wherein the connectivity check comprises a check to determine whether an interface is capable of establishment over the route.

21. Method as claimed in claim 20, wherein the interface is for the performance of at least one of a handover procedure, data forwarding, and measurements exchange between the apparatus and the base station.

22. Method as claimed in claim 19, wherein the neighbour cell list is at the apparatus.

23. Method as claimed in claim 19, wherein the providing connectivity information comprises creating the neighbour cell list.

24. Method as claimed in claim 19, wherein the providing connectivity information comprises updating the neighbour cell list.

25. Method as claimed in claim 19, further comprising performing the connectivity check.

26. Method as claimed in claim 19, wherein the connectivity check includes calculating at least one of round trip delay, packet loss, and sustainable throughput on the route between the apparatus and the respective base station.

27. Method as claimed in claim 19, wherein the providing connectivity information comprises removing a neighbour cell from the neighbour cell list in dependence on results of the connectivity check.

28. Method as claimed in claim 20, further comprising establishing the interface with the respective base station in the at least one neighbour cell included in the list.

29. Method as claimed in claim 19, wherein the at least one neighbour cell includes at least one of a neighbour cell and an overlapping macro cell.

30. A computer program embodied on a computer readable medium, said computer program configured to control a processor to perform:
providing connectivity information for at least one neighbour cell in a neighbour cell list,
said information being dependent on the result of a connectivity check carried out to measure the performance of a route between the apparatus and a respective base station associated with the at least one neighbour cell.

31. Apparatus, comprising:
circuitry arranged to provide connectivity information for at least one neighbour cell in a neighbour cell list,
said information being dependent on the result of a connectivity check carried out to measure the performance of a route between the apparatus and a respective base station associated with the at least one neighbour cell.

32. Apparatus, comprising:
means for receiving a first neighbour cell list including at least one neighbour cell from a home base station; and
means for detecting an inconsistency between the neighbour cell list received from the home base station and at least one neighbour cell list received from at least one respective base station, which respective base station neighbours the home base station.

33. Apparatus as claimed in claim 32, further comprising means for prompting the home base station to rescan for the an element of the first neighbour cell list which generates the inconsistency.

34. Apparatus as claimed in claim 32, further comprising means for receiving a notification from the home base station that a neighbour cell has been removed from the first neighbour cell list.

35. Apparatus as claimed in claim 32, wherein the apparatus comprises a server.

36. Apparatus as claimed in claim 35, wherein the apparatus comprises an operation and maintenance server.

37. Method, comprising:
receiving a first neighbour cell list including at least one neighbour cell from a home base station; and
detecting an inconsistency between the neighbour cell list received from the home base station and at least one neighbour cell list received from at least one respective base station, which respective base station neighbours the home base station.

38. Method as claimed in claim 37, further comprising prompting the home base station to rescan for the an element of the first neighbour cell list which generates the inconsistency.

39. Method as claimed in claim 37, further comprising receiving a notification from the home base station that a neighbour cell has been removed from the first neighbour cell list.

40. A computer program embodied on a computer readable medium, said computer program configured to control a processor to perform:
receiving a first neighbour cell list including at least one neighbour cell from a home base station; and
detecting an inconsistency between the neighbour cell list received from the home base station and at least one neighbour cell list received from at least one respective base station, which respective base station neighbours the home base station.

41. Apparatus, comprising:
a receiver arranged to receive a first neighbour cell list including at least one neighbour cell from a home base station; and
a detector arranged to detect an inconsistency between the neighbour cell list received from the home base station and at least one neighbour cell list received from at least one respective base station, which respective base station neighbours the home base station.
